(19) United States
(12) Patent Application Publication
(10) Pub. No.: US 2025/0093483 A1
(43) Pub. Date: Mar. 20, 2025

(54) TRANSDUCER WITH IMPROVED VELOCITY ESTIMATION ACCURACY SYSTEMS AND METHODS

(71) Applicant: Teledyne Instruments, Inc., Thousand Oaks, CA (US)

(72) Inventors: Jerker Taudien, Shelburne, VT (US); Blair Brumley, San Diego, CA (US)

(21) Appl. No.: 18/967,582

(22) Filed: Dec. 3, 2024

Related U.S. Application Data
(63) Continuation of application No. PCT/US2023/067939, filed on Jun. 5, 2023.
(60) Provisional application No. 63/349,526, filed on Jun. 6, 2022.

(51) Int. Cl. G01S 7/524; G01S 7/527; G01S 15/58; G01S 15/60

(52) U.S. Cl. CPC G01S 7/524; G01S 7/5273; G01S 15/584; G01S 15/60

(57) ABSTRACT

A sonar system and method for measuring relative velocity between a transducer and a scattering surface or volume is disclosed. The system utilizes phased array or piston transducers that project acoustic beams in different directions. Each projection consists of multiple sub-waveforms of different center frequencies that are either frequency steered into different directions such that the acoustic beams ensonify different scatterers or sufficiently separated in frequency to obtain independent estimates of velocity. Each received return signal is used to estimate an independent relative velocity between the transducer and scatterers, and the estimated velocities are averaged to reduce the single-ping standard deviation of the velocity error. Different lags may be used in the different sub-waveforms, wherein shorter lags are used to ambiguity resolve longer lags such that the system ambiguity velocity is sufficiently high, and the single-ping variance decreases below what would be possible when only using a short lag.

### CROSS-REFERENCE TO RELATED APPLICATIONS

This application is a continuation of International Patent Application No. PCT/US2023/067939 filed Jun. 5, 2023 and entitled “TRANSDUCER WITH IMPROVED VELOCITY ESTIMATION ACCURACY SYSTEMS AND METHODS,” which claims priority to and benefit of U.S. Provisional Patent Application No. 63/349,526 filed Jun. 6, 2022 and entitled “TRANSDUCER WITH IMPROVED VELOCITY ESTIMATION ACCURACY SYSTEMS AND METHODS,” all of which are hereby incorporated by reference in their entirety.

### TECHNICAL FIELD

One or more embodiments relate generally to underwater acoustic measurement systems and, more particularly, for example, to a sonar system that includes a transducer assembly with improved velocity estimation accuracy.

### BACKGROUND

Doppler sonars, including Doppler velocity logs (DVL) and acoustic Doppler current profilers (ADCP), measure the relative velocity between the instrument and a group of scatterers by transmitting acoustic pulses along multiple beams that point in different directions and measuring the Doppler shift of the acoustic signal that is scattered back towards the instrument in each beam. The group of scatterers can consist of either suspended particles in the water column to measure currents or a boundary surface, for example the ocean floor, to measure velocity over ground.

Phased array transducers can have an advantage over piston transducers due to a reduced aperture size of the phased array transducer compared to a piston transducer operating at the same frequency. In addition, a phased array transducer can be advantageous because the long-term accuracy of the horizontal velocity may be independent of the speed of sound and a flat aperture configuration may reduce flow disturbances. However, phased array transducers carry a higher cost and exhibit a higher single-ping standard deviation compared to piston transducer configurations.

### SUMMARY

Systems and methods are disclosed that provide a sonar transducer assembly with improved velocity estimation accuracy, in the sense of reduced error standard deviation. Embodiments of the present disclosure provide a sonar system. The sonar system may include a transducer subsystem configured to transmit a plurality of acoustic beams in a plurality of different directions offset from a common axis by a Janus angle. Each acoustic beam may include a transmit waveform including a plurality of sub-waveforms. The plurality of sub-waveforms of each acoustic beam may be transmitted at different center frequencies. In some embodiments, the plurality of sub-waveforms of each acoustic beam may be temporally staggered in time.

Embodiments of the present disclosure provide a method including transmitting, by a transducer subsystem of a sonar system, a plurality of acoustic beams in a plurality of different directions offset from a common axis by a Janus angle. Each acoustic beam may include a transmit waveform including a plurality of sub-waveforms. The plurality of sub-waveforms of each acoustic beam may be transmitted at different center frequencies. In some embodiments, the plurality of sub-waveforms of each acoustic beam may be temporally staggered in time.

Embodiments of the present disclosure provide a sonar system. The sonar system may include a transducer subsystem configured to transmit a single acoustic beam. Each acoustic beam may include a transmit waveform comprising a plurality of sub-waveforms. The plurality of sub-waveforms of each acoustic beam may be transmitted at different center frequencies. In some embodiments, the plurality of sub-waveforms of each acoustic beam may be temporally staggered in time.

The scope of the present disclosure is defined by the claims, which are incorporated into this section by reference. A more complete understanding of embodiments of the present disclosure will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates an example sonar system transmitting a plurality of acoustic beams in a Janus configuration, in accordance with one or more embodiments of the present disclosure.

FIG. 2 illustrates a diagram showing a plurality of sub-waveforms of an acoustic beam transmitted according to a first configuration, in accordance with one or more embodiments of the present disclosure.

FIG. 3 illustrates a diagram showing a plurality of sub-waveforms of an acoustic beam transmitted according to a second configuration, in accordance with one or more embodiments of the present disclosure.

FIG. 4 illustrates a diagram showing a plurality of sub-waveforms of an acoustic beam transmitted according to a third configuration, in accordance with one or more embodiments of the present disclosure.

FIG. 5 illustrates a diagram showing a full bridge transmitter, in accordance with one or more embodiments of the present disclosure.

FIG. 6 illustrates a diagram showing a frequency-selective filtering of received echo returns corresponding to the sub-waveforms, in accordance with one or more embodiments of the present disclosure.

FIGS. 7A-G illustrate diagrams showing power spectral density plots for various modulation schemes, in accordance with one or more embodiments of the present disclosure.

FIG. 8 illustrates a flow diagram of an example process of measuring relative velocity between a transducer and a scattering surface or volume, in accordance with one or more embodiments of the present disclosure.

FIG. 9 illustrates a block diagram of an example system suitable for implementing the process of FIG. 8, in accordance with one or more embodiments of the present disclosure.

Embodiments of the present disclosure and their advantages are best understood by referring to the detailed description that follows. It is noted that sizes of various components and distances between these components are not drawn to scale in the figures. It should be appreciated that like reference numerals are used to identify like elements illustrated in one or more of the figures.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced using one or more embodiments. In one or more instances, structures and components are shown in block diagram form in order to avoid obscuring the concepts of the subject technology. One or more embodiments of the subject disclosure are illustrated by and/or described in connection with one or more figures and are set forth in the claims.

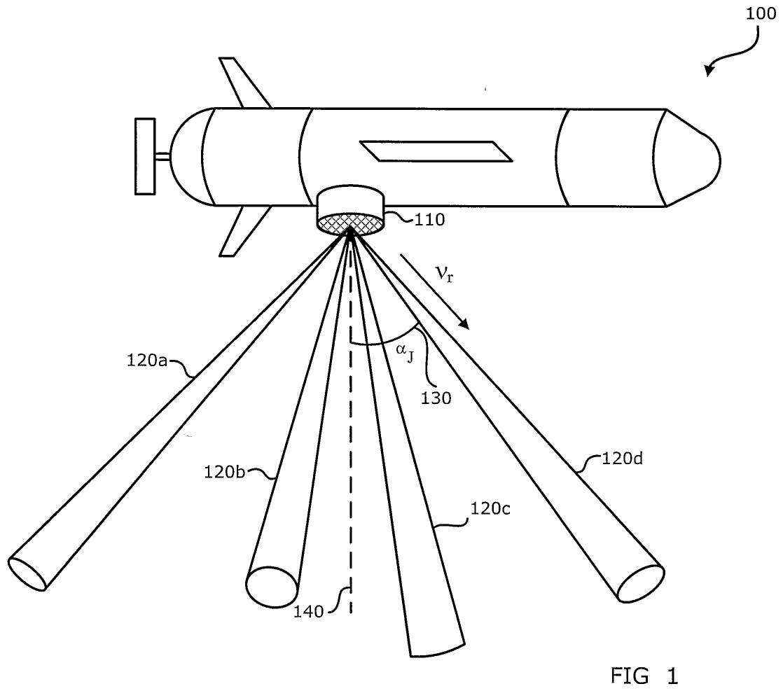

FIG. 1 illustrates an example sonar system transmitting a plurality of acoustic beams in a Janus configuration, in accordance with one or more embodiments of the present disclosure. Referring to FIG. 1, a sonar system 100, such as a Doppler sonar (e.g., a Doppler velocity log (DVL) or an acoustic Doppler current profiler (ADCP)), measures the relative velocity between the sonar system 100 and a group of scatterers by transmitting acoustic pulses along multiple beams that point in different directions and measuring the Doppler shift of the acoustic signal that is scattered back towards the sonar system 100 in each beam. The group of scatterers can consist of either suspended particles in the water column to measure currents or a boundary surface, such as the ocean floor, to measure velocity over ground.

As shown, sonar system 100 includes a transducer subsystem 110 configured to transmit a plurality of acoustic beams 120 (e.g., acoustic beams 120a, 120b, 120c, and 120d) in a plurality of different directions offset from a common axis 140 (e.g., a vertical axis) by a common angle 130 (referred to as the Janus angle α_{J}). In embodiments, the acoustic beams 120 may be separated in azimuth by 90°, although other configurations are contemplated. Depending on the application, sonar system 100 may include a 4-beam configuration (e.g., as illustrated), a 3-beam configuration, a 2-beam configuration, or another configuration (e.g., greater or fewer number of beams as appropriate).

Depending on the application, transducer subsystem 110 may include an assembly of 4-piston transducers, a two-dimensional (e.g., circular) phased array transducer, or a one-dimensional phased array transducer. One-dimensional phased arrays may be capable of generating a single pair of acoustic beams 120. Example one-dimensional phased arrays are disclosed in U.S. Pat. No. 4,641,291, entitled “Phased Array Doppler Sonar Transducer,” and U.S. Pat. No. 5,550,792, entitled “Sliced Phased Array Doppler Sonar System,” both of which are incorporated by reference in their entireties. Two-dimensional phased arrays may be capable of generating two orthogonal pairs of acoustic beams 120. Example two-dimensional phased arrays are disclosed in U.S. Pat. No. 5,808,967, entitled “Two-Dimensional Array Transducer and Beamformer,” which is incorporated by reference in its entirety.

The Janus angle α_{J} of transducer subsystem 110 may be a direct result of transducer design, including based on the spacing between elements of transducer subsystem 110, the frequency of the projected signal, the connectivity between elements of transducer subsystem 110 and the electrical wires, and the relative phase of the signals on the elements of the transducer subsystem 110. The Janus angle α_{J} is typically configured to 300 for Doppler sonar phased array transducers. However, other Janus angles α_{J} are possible based on different combinations of connectivity between transducer elements and different relative phase of the signals on the elements of transducer subsystem 110. For example, transducer subsystem 110 may define a phased array that generates acoustic beams 120 at a 20° Janus angle α_{J}.

As noted above, transducer subsystem 110 may include a phased array configuration or a piston transducer configuration. A phased array configuration may provide a reduced size for a given Janus angle α_{J} configuration (e.g., one-fourth the total area requirement compared to an equivalent transducer array constructed from piston transducers). When peak power is limited by transducer area, projecting multiple beams from a single phased array transducer instead of four individual piston transducers results in less power provided to each acoustic beam 120. A phased array configuration may also offer reduced disturbance of the local flow of water due to a planar transducer face (versus inclined transducers required for a piston transducer configuration). Additionally, when measuring velocity components which are parallel to the transducer face, a phased array configuration is largely immune to local variations in the speed of sound and, if the face is close to horizontal, to steady-state vertical variations of horizontally-stratified sound speed throughout the water column.

A phased array configuration may result in beam broadening when transmitting broadband waveforms. The width of the beam may broaden due to each frequency component of the broadband waveform aimed at an angle slightly different from the Janus angle α_{J}, depending on the difference between the frequency component and the acoustic center frequency. Therefore, the amount of beam broadening depends on the bandwidth of the transmit waveform, and the total beam broadening is a function of the difference between the highest and lowest frequency components of the transmit waveform. An additional cause of beam broadening (even for a single frequency component) may be attributable to the projection of a broadband signal simultaneously from all staves of the array without compensating for the time needed for a phase front perpendicular to the beam to sweep across the front of the array, aside from providing phasing at the carrier frequency. This phenomenon not only increases with increasing signal bandwidth, but also with increasing Janus angle α_{J} and increasing transducer aperture diameter. Further, both kinds of beam broadening may increase the ensonified volume and therefore degrade the spatial resolution. Additionally, the scale-factor bias error of the velocity measurement is proportional to the square of beam width, so beam broadening may contribute to degraded scale-factor accuracy. For such reasons, Doppler sonars utilizing phased array transducers often are configured to transmit waveforms with a narrower bandwidth compared to Doppler sonars utilizing piston transducers. Narrow bandwidths, however, may result in increased standard deviation of the error of the estimated velocity. The standard deviation of the error of the estimated velocity for a single ping is referred to as a single-ping standard deviation.

Broadband waveforms may be used in both piston transducer and phased array transducer sonars. Piston transducers typically operate with a bandwidth up to about 25% of the acoustic carrier frequency, while phased array transducers typically operate with a bandwidth up to about 5-10% to limit beam broadening. The higher bandwidth at which piston transducers operate contributes to a lower single-ping standard deviation by a factor of the reciprocal of the square root of the bandwidth ratio. For example, the single-ping standard deviation of a transducer operating at 6.25% is a factor of two higher than that of a transducer operating at 25% bandwidth. Averaging of four pings is required to reduce the standard deviation by a factor of two. The bandwidth limitation of phased array transducers is a result of beamwidth broadening and the associated degradation of the long-term accuracy and spatial resolution.

One or more disclosed embodiments may overcome the single-ping standard deviation disadvantage of phased array transducer configurations as compared to piston transducer configurations. The disclosed embodiments may also overcome the peak power disadvantage of phased array transducer configurations by, for example, sequentially projecting a number of pulses in different frequency bands, as described below, resulting in a longer total projection time and hence more power in the backscattered signal.

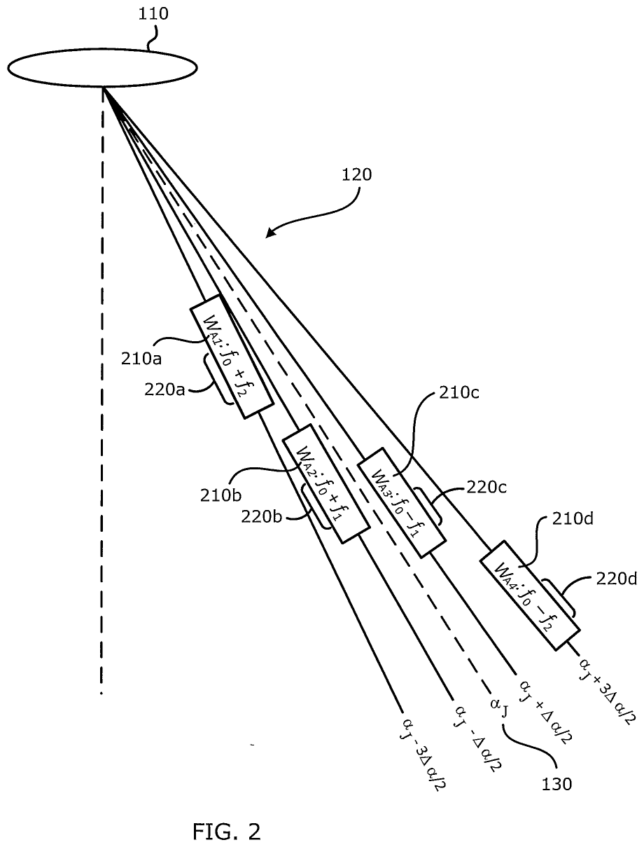

FIG. 2 illustrates a diagram showing a plurality of sub-waveforms of an acoustic beam 120 (e.g., one of the acoustic beams 120a, 120b, 120c, or 120d in FIG. 1) transmitted according to a first configuration, in accordance with one or more embodiments of the present disclosure. Referring to FIG. 2, transducer subsystem 110 may utilize multiple near-simultaneous and independent observations in space to obtain a reduction of the single-ping standard deviation. For example, each acoustic beam 120 may include a transmit waveform including a plurality of sub-waveforms 210 (e.g., sub-waveforms W_{A1}, W_{A2}, W_{A3}, and W_{A4} with reference numbers 210a, 210b, 210c, and 210d, respectively). The sub-waveforms 210 of each acoustic beam 120 may be transmitted at different center frequencies 220 (e.g., center frequencies 220a, 220b, 220c, and 220d, respectively) and temporally staggered in time, as detailed more fully below.

Transducer subsystem 110 may use frequency steering in transmitting the sub-waveforms 210. In embodiments, frequency steering may not require any additional hardware beyond what is typically already included in a Doppler sonar. To obtain an independent sample, the steering angle from nominal could be at least approximately greater than or equal to the beam width for the ensonified volumes of the ping aimed at Janus angle α_{J} and the steered ping to not overlap in space. Alternatively, the number of wavelengths in the averaging bin could be large compared to the reciprocal of the frequency difference between the bands. A phased array transducer may utilize both spatial independence and independence from re-phasing scatterers at different frequencies. A piston transducer configuration may utilize re-phasing of scatterers at different frequencies to obtain independent samples.

A generic example of transmitting and frequency steering is shown in FIG. 2. In the illustrative embodiment of FIG. 2, the transmit waveform includes four sub-waveforms 210, where each sub-waveform 210 has a bandwidth and center frequency 220. The nominal center frequency of transducer subsystem 110 (f₀) may be defined to generate an acoustic beam 120 in the direction of the Janus angle α_{J}. Each of the sub-waveforms 210 has a different center frequency f_{c}=f₀+fₙ, 1≤n≤N, where N is the total number of sub-waveforms 210. For a phased array transducer configuration, each sub-waveform 210 of each acoustic beam 120 may be transmitted at an angle offset from the Janus angle α_{J}. The angle offset may be determined based on the number of sub-waveforms 210. For example, the angle offset may be given by the equation:

$${α}_{J} - ( n - \frac{N + 1}{2} ) Δ α , \qquad ( 1 )$$

where Δα is the angular spacing between the frequency-steered sub-waveforms 210.

In embodiments, the angle offset may be determined based on a beamwidth of the phased array transducer. For example, for a particular phased array with inter-element spacing set to λ₀/2 and inter-element phasing set to ϕ radians, the angular spacing could be set equal to the beamwidth of the transducer. The associated frequencies could be selected according to:

$$f = {f}_{0} \frac{sin ( {α}_{J} )}{sin ( α )} = \frac{{f}_{0} ϕ}{π sin ( α )} , \qquad ( 2 )$$

where f₀ is the operating frequency of the phased array transducer.

For example, the beam width of a 7.2 cm diameter, 200 Janus angle (ϕ=π/3), phased array transducer operating at 600 kHz may be approximately 2.1°. As an example, sub-waveforms 210a, 210b, 210c, 210d could be transmitted in a staggered fashion (e.g., temporally staggered in time) at approximate angles α_{J} minus 3°, α_{J} minus 1°, α_{J} plus 1°, and α_{J} plus 3°, respectively. In such embodiments, respective ratios of the different center frequencies relative to the operating frequency of the transducer subsystem 110 (f/f₀) may be 1.17, 1.05, 0.95, and 0.87. Sub-waveforms 210a, 210b, 210c, 210d may be temporally staggered in many configurations. For example, sub-waveforms 210a, 210b, 210c, 210d may be transmitted sequentially in time back-to-back or transmitted sequentially in time with a gap in between the sub-waveforms. The gap may be constant or variable and can be set to zero or any number greater than zero. Other configurations are also contemplated.

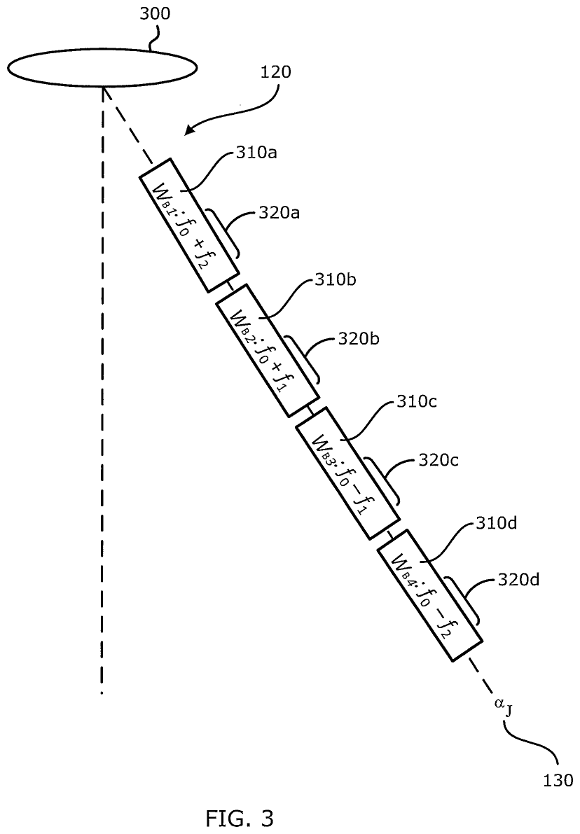

FIG. 3 illustrates a diagram showing sub-waveforms 310 of an acoustic beam 120 (e.g., one of the acoustic beams 120a, 120b, 120c, or 120d in FIG. 1) transmitted according to a second configuration, in accordance with one or more embodiments of the present disclosure. A generic piston transducer 300 configuration is illustrated in FIG. 3, showing four sub-waveforms 310, although any number of sub-waveforms 310 can be utilized. In the illustrative embodiment of FIG. 3, the transmit waveform includes four sub-waveforms W_{B1}, W_{B2}, W_{B3}, and W_{B4} with reference numbers 310a, 310b, 310c, and 310d, respectively, where each sub-waveform 310 has a bandwidth and a center frequency 320 (e.g., center frequencies 320a, 320b, 320c, and 320d, respectively). The Janus angle α_{J} of all sub-waveforms 310 at different center frequencies 320 may be constant (i.e., each sub-waveform 310 of each acoustic beam 120 may be transmitted at the Janus angle α_{J}). The Janus angle α_{J} of the piston transducer 300 can be configured to any value by mechanically pointing the piston transducer 300 in the desired direction. Similar to the phased array configuration of FIG. 2, sub-waveforms 310 may be temporally staggered in time. The piston transducer 300 configuration may include four piston transducers each configured to transmit a respective acoustic beam 120.

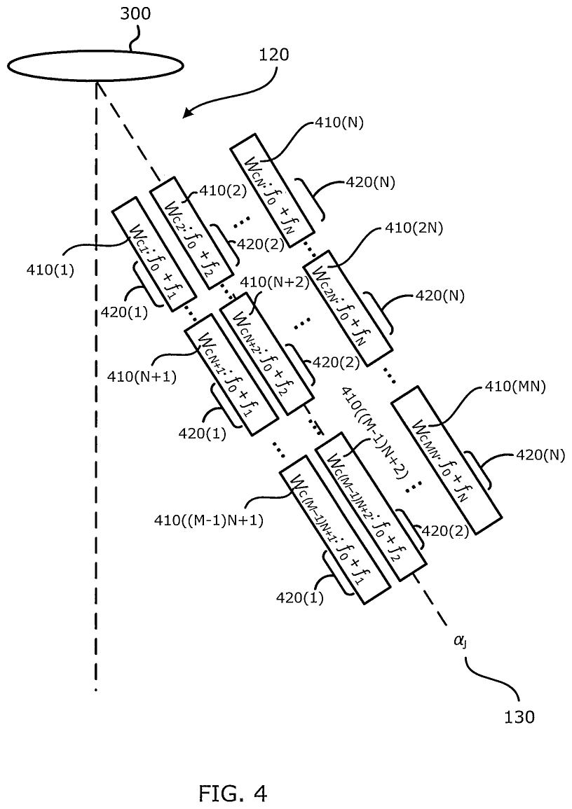

FIG. 4 illustrates a diagram showing sub-waveforms of an acoustic beam transmitted according to a third configuration, in accordance with one or more embodiments of the present disclosure. In FIG. 4, piston transducer 300 is utilized to transmit M times N (i.e., M×N) sub-waveforms 410 at center frequencies 410, where N is the number of unique center frequencies of simultaneously transmitted sub-waveforms 410 and M is the number of staggered groups of sub-waveforms 410.

In the illustrative embodiment of FIG. 4, the transmit waveform includes M times N sub-waveforms 410 W_{C1} to W_{CMN} with reference numbers 410(1) to 410(MN), where each sub-waveform 410 has a bandwidth and a center frequency 420 (e.g., center frequencies 420(1) to 420(N)). In this regard, various groups (e.g., subsets) of sub-waveforms 410 having different center frequencies 420 may be transmitted simultaneously. For example, group of sub-waveforms 410(1) to 410(N) may be transmitted simultaneously with each other, group of sub-waveforms 410(N+1) to 410(2N) may be transmitted simultaneously with each other, and group of sub-waveforms 410((M−1)N+1) to 410(2N) may be transmitted simultaneously with each other. In addition, various groups (e.g., subsets) of sub-waveforms 410 may be temporally staggered in time. For example, group of sub-waveforms 410(1) to 410(N) may be temporally staggered in time in relation to group of sub-waveforms 410(N+1) to 410(2N), and further in relation to group of sub-waveforms 410((M−1)N+1) to 410(2N).

The Janus angle α_{J} of all sub-waveforms 410 at different center frequencies 420 may be constant (i.e., each sub-waveform 410 of each acoustic beam may be transmitted at the Janus angle α_{J}). The Janus angle α_{J} of the piston transducer 300 can be configured to any value by mechanically pointing the piston transducer 300 in the desired direction. Similar to the phased array configuration of FIG. 2, sub-waveforms 410 may be temporally staggered in time or separated by gaps. The piston transducer 300 configuration may include four piston transducers each configured to transmit a respective acoustic beam. This transmission scheme with simultaneous sub-waveforms 410 may also be utilized in combination with phased array transducer 110 in some embodiments.

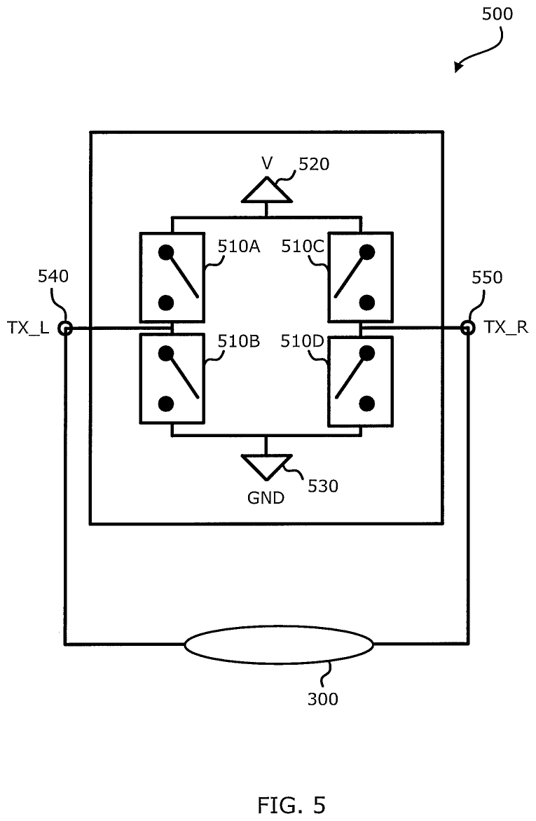

Transmitter circuits commonly used in Doppler sonars include push-pull transformer configurations, half-bridge transmitters, full-bridge transmitters, and similar architectures that drive transistors in their saturation regions when they are turn on. An example full-bridge transmitter 500 is shown in FIG. 5. Switches 510A and 510B are connected between a voltage source 520 and a ground 530 in parallel with switches 510C and 510D as shown. Left and right nodes 540 and 550 pass current between switches 510A-D and piston transducer 300.

Groups of switches 510A/510D and 510B/510C may selectively turn on and off to pass current to piston transducer 300 for transmitting various acoustic beams comprising sub-waveforms as discussed herein. For example, when switches 510A and 510D are on, and switches 510B and 510C are off, current passes from voltage source 520, through switch 510A, node 540, piston transducer 300, node 550, and switch 510D, and finally to ground 520. When switches 510A and 510D are off, and switches 510B and 510C are on, current passes from voltage source 520, through switch 510C, node 550, piston transducer 300, node 540, and switch 510B, and finally to ground 520.

Such architectures are advantageously power efficient. In some embodiments, simultaneous generation of multiple sub-waveforms at different center frequencies may be accomplished by using one full-bridge transmitter 500 for each simultaneous sub-waveform and summing the sub-waveforms generated by each full-bridge transmitter 500 using a transformer with multiple primary windings.

The receiver of a Doppler sonar operating in monostatic mode, where one transducer is used to both transmit and receive, typically does not operate during the time when the transmitter is active. This time duration is referred to as the blanking period. In some embodiments, transmission of multiple simultaneous sub-waveforms of different center frequencies and bandwidths may reduce the duration of such blanking periods.

FIG. 64 illustrates a diagram showing a frequency-selective filtering of received echo returns corresponding to sub-waveforms 210/310, in accordance with one or more embodiments of the present disclosure. The received echo returns corresponding to sub-waveforms 210/310 may be sufficiently separated from one another to separately compute the Doppler shifts and corresponding velocities of the echo returns corresponding to the sub-waveforms 210/310 over desired bins 610, spatially distributed in the scattering medium. In embodiments, separating the received echo returns can be done through frequency-selective filtering if power spectral densities of the received echo returns corresponding to the transmitted sub-waveforms 210/310 are substantially disjoint.

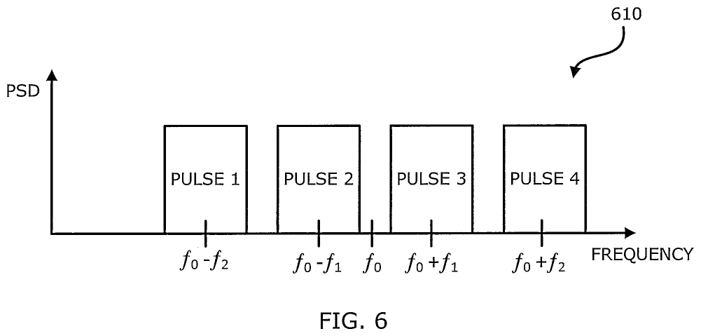

One such case, including four sub-waveforms 210/310 is shown in FIG. 6. A realizable filter bank with roll-off width approximately less than the frequency separation of sub-waveforms 210/310 adjacent in frequency could separate the sub-waveforms 210/310 into signals substantially consisting of only one sub-waveform 210/310 each. To substantially separate the sub-waveforms 210/310, the power spectral density (PSD) of the frequency sidelobes of the transmit modulation scheme may be below a maximum threshold at frequencies greater than f_{c}+B/2 and less than f_{c}−B/2, where f_{c} is the carrier frequency (center frequency) of the transmitted signal at the center of one typical band and B is the permissible transmit bandwidth between the nearest edges of neighboring bands 610 created by the filter bank.

Various modulation schemes may be used, such as minimum-shift keying (MSK) with sidelobes that roll off quickly past a band edge is minimum-shift keying (MSK), such as that disclosed in U.S. Pat. No. 2,977,417, which is incorporated by reference in its entirety. Other modulation schemes such as binary phase-shift keying (BPSK), quadrature phase shift keying (QPSK), and/or others are also contemplated.

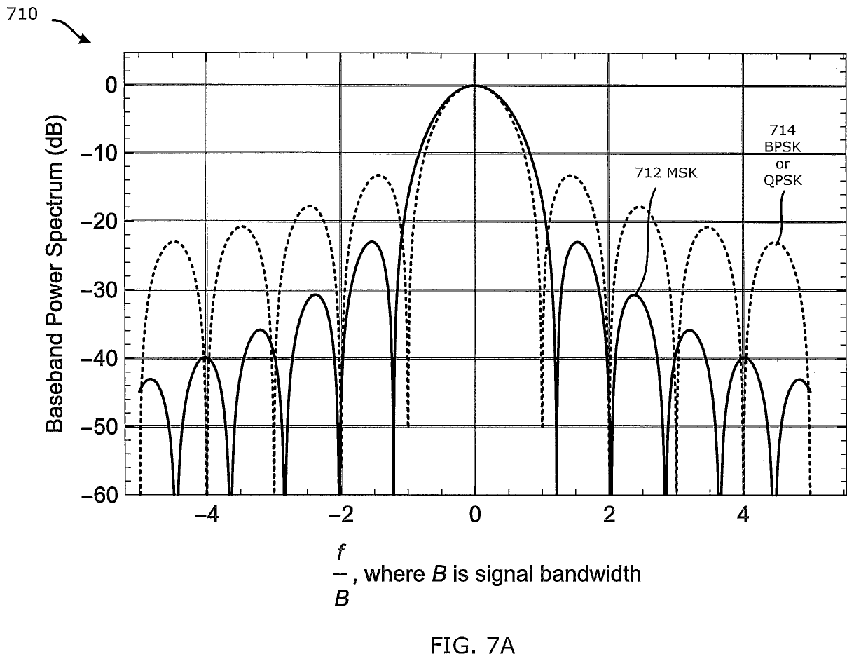

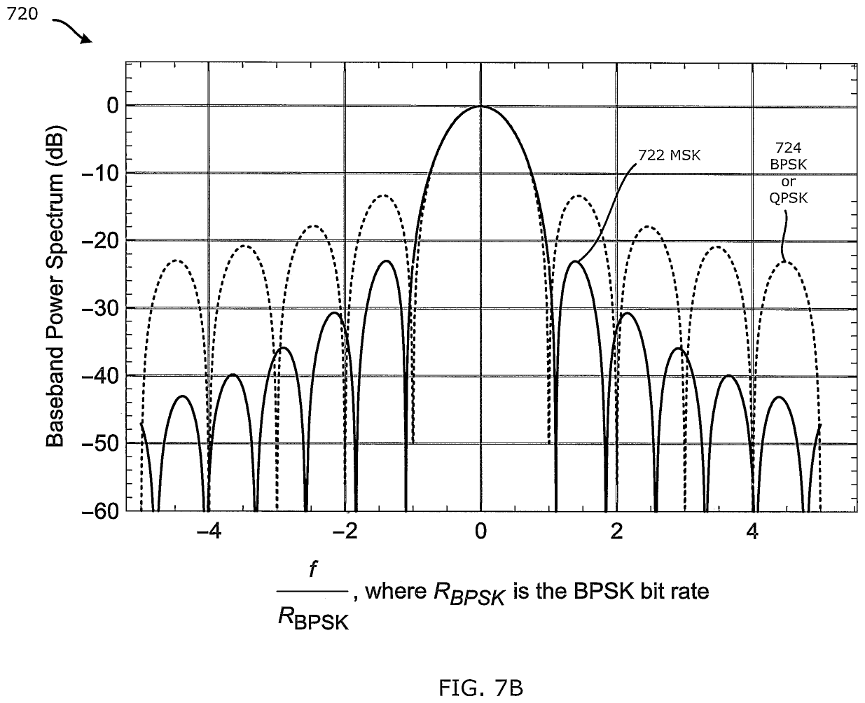

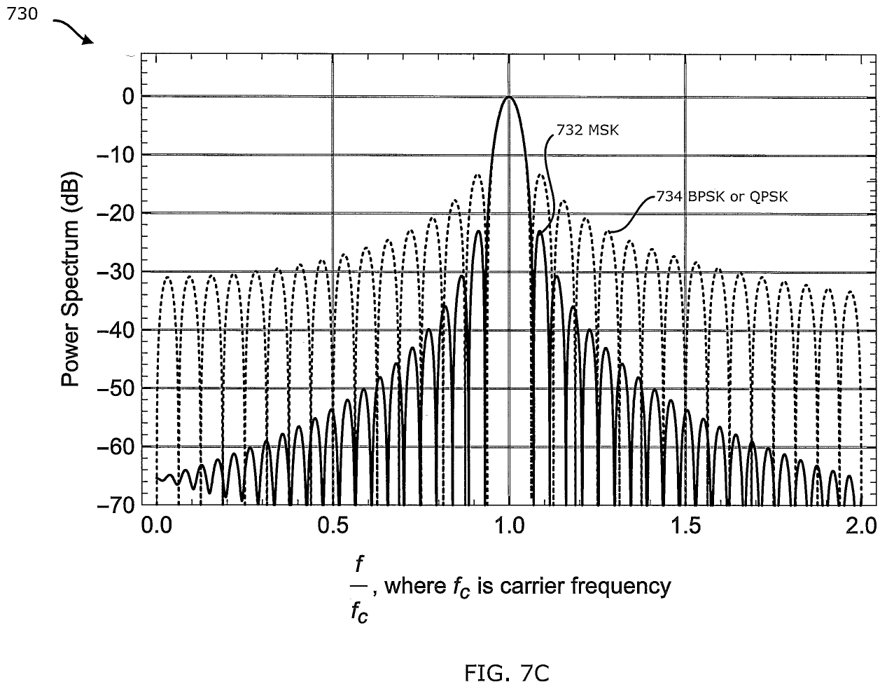

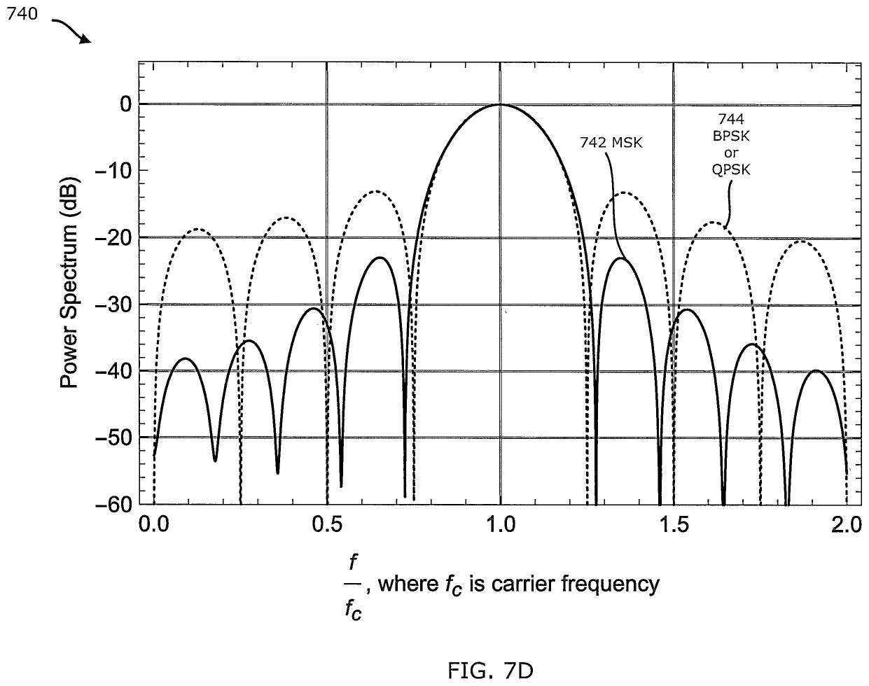

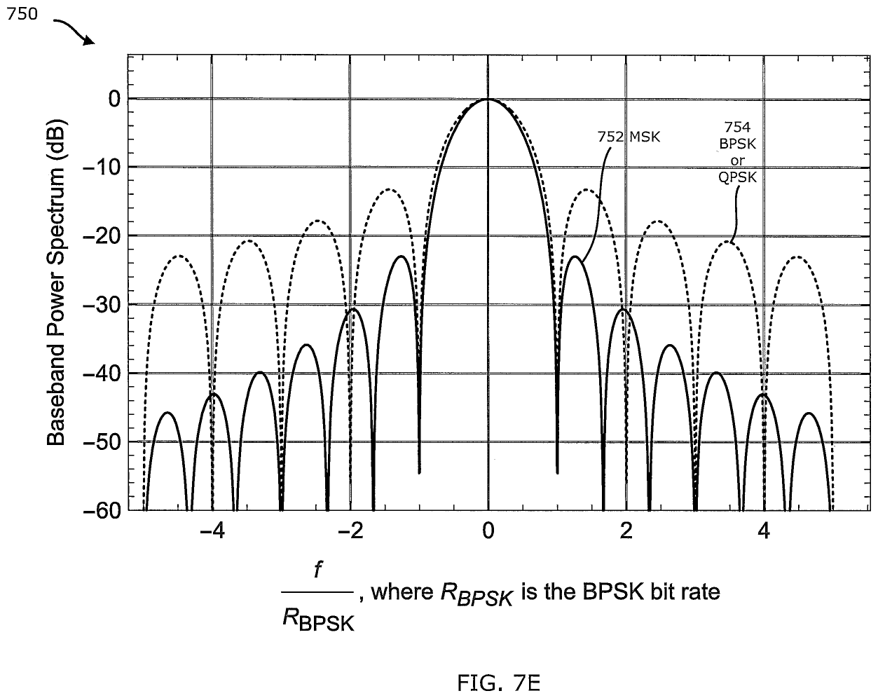

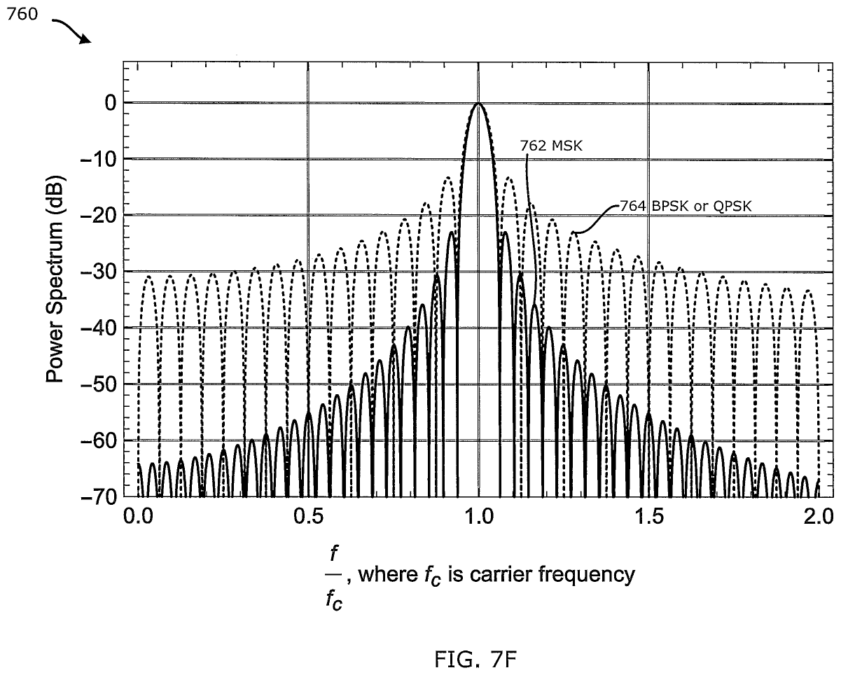

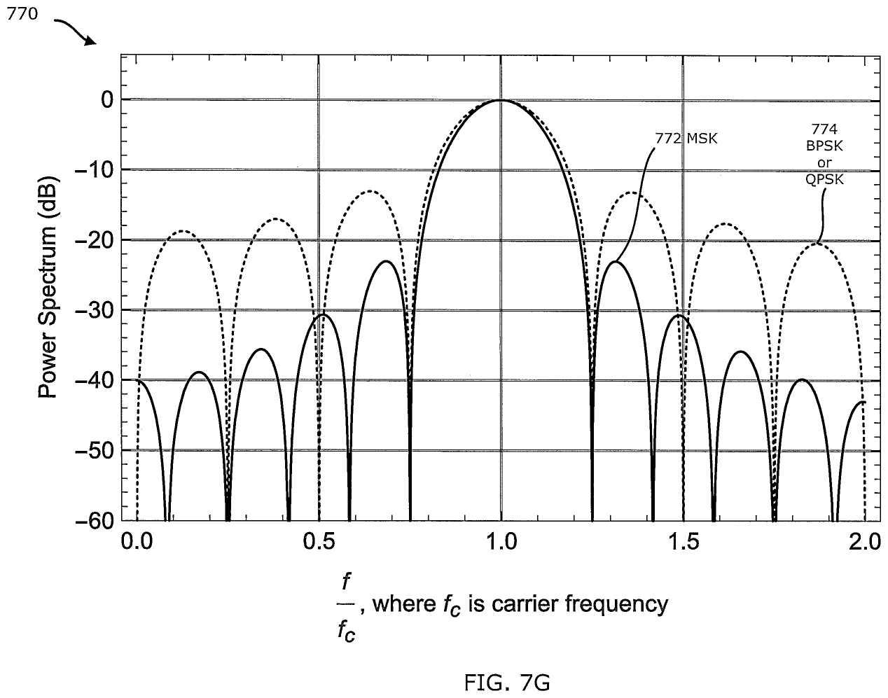

For example, FIGS. 7A-G illustrate diagrams showing power spectral density plots for various modulation schemes, in accordance with one or more embodiments of the present disclosure. In FIGS. 7A-G, the spectral envelope is plotted, but the comb spectrum due to code repetitions and the power spectrum of the code are not shown, both of which stay within the spectral envelope. In addition, FIGS. 7A-G do not account for the transducer efficiency spectrum which would result in reduced sidelobes relative to the main lobe than shown.

FIG. 7A illustrates a diagram 710 of baseband power density plots 712 and 714 for MSK and BPSK/QPSK waveforms, respectively, having a bit rate ratio of 1.621, in accordance with one or more embodiments of the present disclosure. In FIG. 7A, power density plots 712 and 714 illustrate the envelope of the baseband power spectral density of an MSK code (plot 712) compared with a BPSK or QPSK code (plot 714), where the bit rate has been adjusted to match the total bandwidths (e.g., being for each the area under the power spectral density envelope integrated over all frequencies from −∞ to +∞). In this regard, a QPSK signal may utilize twice the bit rate to achieve the same bandwidth as a BPSK signal. When QPSK and BPSK signal bandwidths are matched, the two power spectral envelopes are then identical as represented by plot 714. To match the MSK signal total bandwidth with that of the BPSK/QPSK signals, the MSK signal bit rate may be greater than that of the BPSK signal by a bit rate ratio (e.g., factor) of 16/π²≅1.621 to provide diagram 710 of FIG. 7A.

In some cases, the main lobes (e.g., centered at zero) of plots 712 and 714 are the most useful, while the sidelobes do not contribute to useful portions of the bandwidth of the MSK and BPSK signals. The sidelobe portion of plot 712 is only 0.5% for the MSK signal (−23.0 dB). In contrast, the sidelobe portion of plot 714 is significantly larger at 9.7% for the BPSK signal (−10.1 dB). To substantially match the BPSK and MSK bandwidths corresponding to the areas under the normalized main lobes of the baseband spectral envelopes, the MSK-to-BPSK bit rate signal factor may be smaller than identified above, such as approximately 1.471.

Although the main lobe shapes of plots 712 and 714 do not exactly overlap (e.g., as shown in FIG. 7A), a 1.471 bit rate ratio would permit them to match at the −6.2 dB point, which is very close to matching the −6 dB bandwidths. In some embodiments, the bandwidths between first nulls do not exactly match using the 1.471 bit rate ratio, such that the MSK spectrum is wider than that of the BPSK spectrum by a factor of (3/4)(1.471)≅1.103.

Accordingly, FIG. 7B reflects this change in the MSK-to-BPSK bit rate ratio with a diagram 720 of baseband power density plots 722 and 724 for MSK and BPSK/QPSK waveforms, respectively, having a bit rate ratio of 1.471, in accordance with one or more embodiments of the present disclosure.

In addition, FIG. 7C illustrates a diagram 730 of phased array transducer power density plots 732 and 734 for MSK and BPSK/QPSK waveforms, respectively, having a bit rate ratio of 1.471, in accordance with one or more embodiments of the present disclosure. In FIG. 7C, the BPSK bit rate is 6.25% of the carrier frequency and the MSK bit rate is 9.19% of the carrier frequency.

FIG. 7D illustrates a diagram 740 of piston transducer power density plots 742 and 744 for MSK and BPSK/QPSK waveforms, respectively, having a bit rate ratio of 1.471, in accordance with one or more embodiments of the present disclosure. In FIG. 7D, the BPSK bit rate of 25% of the carrier frequency and the MSK bit rate is 36.8% of the carrier frequency.

In some embodiments, an MSK-to-BPSK bit rate ratio of 4/3 (e.g., 1.333) may be used to match the bandwidths of first null bandwidths of power density plots. For example, FIG. 7E illustrates a diagram 750 of baseband power density plots 752 and 754 for MSK and BPSK/QPSK waveforms, respectively, having a bit rate ratio of 1.333, in accordance with one or more embodiments of the present disclosure.

FIG. 7F illustrates a diagram 760 of phased array power density plots 762 and 764 for MSK and BPSK/QPSK waveforms, respectively, having a bit rate ratio of 1.333, in accordance with one or more embodiments of the present disclosure. In FIG. 7F, the BPSK bit rate is 6.25% of the carrier frequency and the MSK bit rate is 8.33% of the carrier frequency.

FIG. 7G illustrates a diagram 770 of piston transducer power density plots 772 and 774 for MSK and BPSK/QPSK waveforms, respectively, having a bit rate ratio of 1.333, in accordance with one or more embodiments of the present disclosure. In FIG. 7G, the BPSK bit rate is 25% of the carrier frequency and the MSK bit rate is 33.3% of the carrier frequency.

Regarding MSK-based modulation, these modulation signals may be members of the larger category of continuous-phase signals, which avoid discontinuities in phase and amplitude during the entire projection period. The quick roll off of the spectrum as frequency to the exponent −4 may be attributable to this smoothness in the time domain. The baseband power spectrum of MSK signals may be given by:

$${P}_{M S K} ( f ) = \frac{16}{{π}^{2}} {( \frac{cos ( 2 π f / R )}{16 {( f / R )}^{2} - 1} )}^{2} , \qquad ( 3 )$$

where R is the code bit rate.

MSK signals may be easily generated by switching between two frequencies at times when their phases coincide, which occur at the bit rate R, twice the difference between the two frequencies. Another description of MSK modulation signals at baseband is the convolution of a half-cosine function with a uniformly-spaced coded sequence of complex Dirac delta functions that alternate between real and imaginary values of constant magnitude, given by the following equation:

$${S}_{M S K} ( t ) = \{ \begin{matrix}Λ {\sum }_{n = 0}^{N} {C}_{n} {i}^{n} {f}_{halfcos} ( t - \frac{n}{R} ) , & 0 \leq Rt \leq N \\ 0 & elsewhere\end{matrix} \qquad ( 4 )$$

$$The half - cosine function is {f}_{halfcos} ( t ) = \{ \begin{matrix}cos ( \frac{1}{2} π R t ) , & - 1 \leq Rt \leq 1 \\ 0 & elsewhere\end{matrix} \qquad ( 5 )$$

$$The code sequence is {C}_{n} = \pm 1. \qquad ( 6 )$$

In Eqn. 4, A may have a constant amplitude because only two half-cosine functions are active at any one time, and they are 90° out of phase. Such examples are illustrative only, and other modulation schemes may include, without limitation, binary phase-shift keying, quadrature phase-shift keying, frequency-shift keying, and chirps.

Each of the filtered signals could be used to compute the Doppler shifts and associated velocities over a profile of multiple bins, where vₖ(m) is the estimated velocity in bin m computed from received sub waveform k. The averaged velocity in each bin may be computed according to:

$$v ( m ) = \frac{1}{K} {\sum }_{k = 1}^{K} {v}_{k} ( m ) , \qquad ( 7 )$$

where K is the total number of sub-waveforms 210. For truly independent observations of the velocities in the bins and equal standard deviation of each sub estimate, the standard deviation of the averaged estimate may decrease according to:

$$σ = \frac{{σ}_{s}}{\sqrt{K}} , \qquad ( 8 )$$

where σₛ is standard deviation of a single sub estimate.

Different lags can be used in the different sub-waveforms 210/310, wherein the shorter lags may be used to ambiguity resolve the longer lags such that the system ambiguity velocity is sufficiently high and the single-ping variance decreases below what would be possible when only using a short lag. Therefore, the disclosed embodiment overcomes the tradeoff between ambiguity velocity and single-ping standard deviation that conventional ADCPs are subject to.

The ambiguity resolution strategy can be employed to reduce the single-ping variance significantly for both phased array and piston transducer systems. The radial ambiguity velocity may be computed according to:

$${U}_{a} = \frac{c}{4 {f}_{c} {T}_{L}} , \qquad ( 9 )$$

where c is the speed of sound, f_{c} is the carrier frequency, and T_{L} is the correlation time lag, the time interval with which the code is repeated. The transmit duration for a given bin size D_{bin} may be given by:

$${T}_{b i n} = \frac{2 {D}_{b i n}}{c cos ( {α}_{J} )} , \qquad ( 10 )$$

The number of code elements M and code repetitions Nᵣₑₚ can be selected such that:

$${T}_{b i n} \approx \frac{M {N}_{r e p}}{R} , \qquad ( 11 )$$

The choice of the code length may be based on the desired ambiguity velocity and the lag L in number of code elements may be equal to M. A simplified equation predicting approximate single-ping horizontal velocity standard deviation under high signal-to-noise conditions may be given by:

$$S T D ( {v}_{e} ) = \frac{{U}_{a}}{π} \sqrt{( \frac{I - {ρ}^{2}}{2 M {ρ}^{2}} )} \frac{\sqrt{2}}{2 sin ( {α}_{J} )} , \qquad ( 12 )$$

where ρ is the correlation coefficient.

As one example, using Eqn. 12 the single-ping horizontal standard deviation of a conventional 614 kHz piston transducer with 20° Janus angle α_{J}, 53 element code, and a 2 m bin size may be approximately 5.8 cm/s. In some embodiments, sonar system 100 and/or transducer subsystem 110 may be implemented in accordance with the features shown in the following Table 1:

TABLE 1

| Parameter | Value |
|---|---|
| Bin Size | 2 m |
| Code Type | MSK |
| Code Rate | f_{c}/12 |
| Code Length | 145 |
| Sub-waveform 1 | 145 element MSK |
| (e.g., sub-waveform 210a) | |
| Sub-waveform 2 | 2 m bin MSK with ambiguity resolution |
| (e.g., sub-waveform 210b) | |
| Sub-waveform 3 | 2 m bin MSK with ambiguity resolution |
| (e.g., sub-waveform 210c) | |
| Sub-waveform 4 | 145 element MSK |
| (e.g., sub-waveform 210d) | |

In some embodiments, using Eqn. 9 above, the radial ambiguity velocity of the long lag may be Uₐ=0.0717 m/s, and the predicted single-ping standard deviation, using Eqn. 12, may be 0.48 cm/s. In some embodiments, using Eqn. 8 above, it would require approximately 146 averaged pings from the conventional ADCP to match the single-ping standard deviation of the disclosed embodiment utilizing the ambiguity resolution scheme.

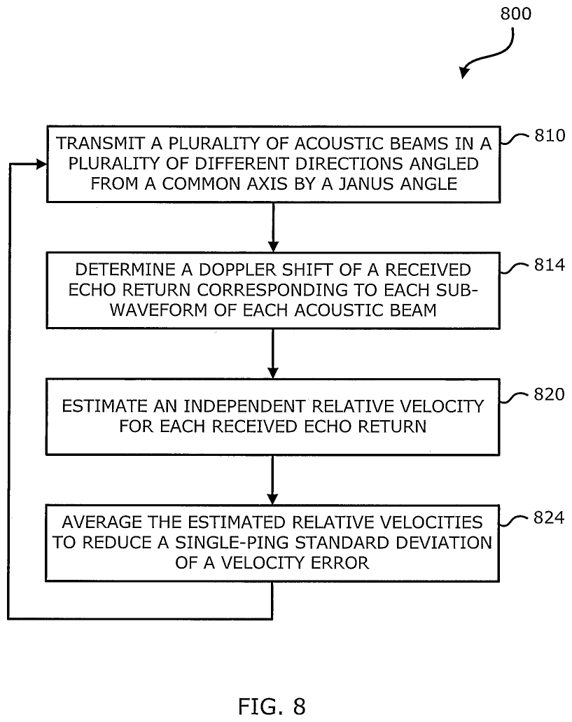

FIG. 8 illustrates a flow diagram of an example process 800 of measuring relative velocity between a transducer (e.g., transducer subsystem 110) and a scattering surface or volume, in accordance with one or more embodiments of the present disclosure. For explanatory purposes, process 800 is described herein with reference to FIGS. 1-4, although process 800 is not limited by the components of FIGS. 1-4.

In block 810, process 800 includes transmitting, by transducer subsystem 110, a plurality of acoustic beams 120 (e.g., acoustic beams 120a, 120b, 120c, and 120d) in a plurality of different directions offset from common axis 140 by Janus angle α_{J}. Each acoustic beam 120 includes a transmit waveform including a plurality of sub-waveforms (e.g., sub-waveforms 210 and/or sub-waveforms 310), such as four sub-waveforms (e.g., sub-waveforms 210a, 210b, 210c, and 210d or sub-waveforms 310a, 310b, 310c, and 310d). The sub-waveforms may be transmitted at different center frequencies and temporally staggered in time. The associated frequencies of the sub-waveforms may be selected according to Eqn. 2 above. The scattering surface or volume may include at least one of suspended particles in a water column to measure currents or a boundary surface to measure velocity over ground.

Transducer subsystem 110 may include many configurations. For example, transducer subsystem 110 may include a phased array transducer and/or a plurality of piston transducers configured to transmit acoustic beams (e.g., acoustic beams 120). For a phased array transducer configuration, each sub-waveform of the transmitted acoustic beam (e.g., sub-waveforms 210a, 210b, 210c, and 210d) may be transmitted at an angle offset from the Janus angle α_{J}. The angle offset may be determined based at least on the number of sub-waveforms and a beamwidth of the phased array transducer. For example, the angle offset of each sub-waveform may be determined by Eqn. 1 above.

For piston transducer configurations, each sub-waveform of the transmitted acoustic beam (e.g., sub-waveforms 310a, 310b, 310c, and 310d) may be transmitted at the Janus angle α_{J}. In one example, transducer subsystem 110 includes four piston transducers each configured to transmit a respective acoustic beam 120, although other configurations are contemplated. For example, first, second, third, and fourth piston transducers may be configured to transmit acoustic beams 120a, 120b, 120c, and 120d, respectively.

In block 814, process 800 may include determining a Doppler shift of a received echo return corresponding to each sub-waveform. For example, a logic device or processor (e.g., controller 610) may be configured to determine Doppler shifts of the received echo returns, as discussed herein. Block 814 may include separating the received echo returns through frequency-selective filtering, such as by controller 610 discussed herein.

In block 820, process 800 may include estimating, for each received echo return corresponding to each sub-waveform, an independent relative velocity between the transducer element (e.g., transducer subsystem 110) and the scattering surface or volume, such as by controller 610 discussed herein. The received signals may be separated through frequency-selective filtering. The code lengths of each of the multiplicity of sub-waveforms may be identical, vary slightly, or vary by large factors. One or more of the sub-waveforms may be used for ambiguity resolution, each independently in the case of shorter codes or in combination in the case of long but somewhat differing code lengths. Another option, illustrated in the example of Table 1, is to make two of the sub-waveforms identical (the first and fourth in the example) and make Doppler velocity measurements based upon the correlation of their returns.

In block 824, process 800 may include averaging the estimated relative velocities to reduce a single-ping standard deviation of a velocity error, such as by controller 610 discussed herein. Such averaging may be weighted or unweighted, and may omit some short-code measurements used solely for ambiguity resolution. In embodiments, process 800 may be repeated, such as continuously or near-continuously. For example, blocks 810, 814, 820, and 824 may be repeated during operation of sonar system 100.

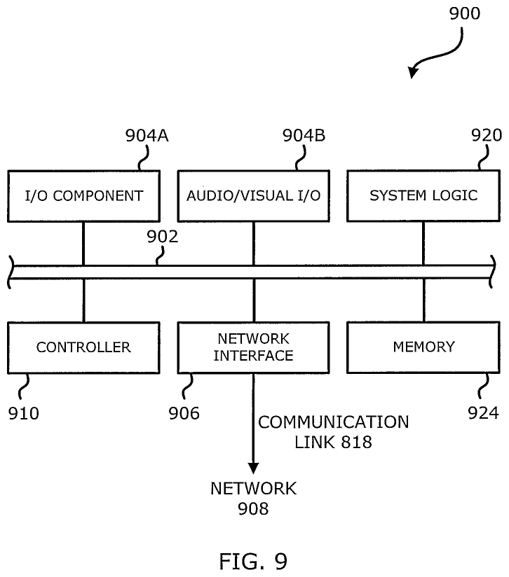

FIG. 9 illustrates a block diagram of an example system 900 (e.g., a computer or processing system) suitable for implementing process 800 of FIG. 8, in accordance with one or more embodiments of the present disclosure. In embodiments, system 900 may be implemented in sonar system 100. In various embodiments, system 900 may include a computing device (e.g., smart phone, a tablet, a computer, laptop, etc.) or a network computing device (e.g., a network server), both of which are capable of communicating with a network 908.

As shown, system 900 includes a bus 902 or other communication mechanism for communicating data, signals, and information between various components of system 900. For example, components of system 900 include, according to one implementation, an input/output (I/O) components 904A, an audio/visual I/O component 904B, a network interface 906, one or more controllers 910, a communication link 918, system logic 920, and a memory component 924, or any combination thereof.

I/O component 904A may process a user action, such as selecting keys from a keypad/keyboard and/or selecting one or more buttons, images, or links, such as for inputting or accessing/requesting data, and sends a corresponding signal to bus 902. I/O component 904A may also include an output component, such as a display and a cursor control (such as a keyboard, keypad, mouse, etc.). The display may present information to the user, such as via a light emitting diode (LED) display, a liquid crystal display (LCD), an organic light emitting diode (OLED) display, and/or any other appropriate display. Audio/visual I/O component 904B may be included to allow a user to use voice for inputting information by converting audio signals and/or input or record images/videos by capturing visual data. Audio/visual I/O component 904B may allow the user to hear audio and view images/video.

Network interface 906 may transmit and receive signals between system 900 and other devices, such as another communication device, service device, or a service provider server via network 908. In one embodiment, the transmission is wireless, although other transmission mediums and methods may also be suitable.

Controller 910, which may be referred to as a logic device, may be implemented as one or more microprocessors, microcontrollers, application specific integrated circuits (ASICs), programmable logic devices (PLDs) (e.g., field programmable gate arrays (FPGAs), complex programmable logic devices (CPLDs), field programmable systems on a chip (FPSCs), digital signal processor (DSP), or other processing component. Controller 910 may process various signals of system 900, such as for display on system 900 or transmission to other devices via communication link 918. In embodiments, controller 910 may execute various operations of sonar system 100 described herein. For example, controller 910 may be configured, by hardwiring, executing software instructions, or a combination of both, to perform various operations discussed herein for embodiments of the disclosure.

Communication link 918 may include wired and/or wireless interfaces. Wired interfaces may include communications links with various test station components and may be implemented as one or more physical networks or device connect interfaces (e.g., Ethernet, and/or other protocols). Wireless interfaces may be implemented as one or more Wi-Fi, Bluetooth, cellular, infrared, radio, and/or other types of network interfaces for wireless communications and may facilitate communications with wireless devices of sonar system 100 and/or other systems.

System logic 920 may be implemented as circuitry and/or a machine-readable medium storing various machine-readable instructions and data. For example, in some embodiments, system logic 920 may store an operating system and one or more applications as machine readable instructions that may be read and executed by controller 910 to perform various operations described herein. In some embodiments, system logic 920 may be implemented as non-volatile memory (e.g., flash memory, hard drive, solid state drive, or other non-transitory machine-readable mediums), volatile memory, or combinations thereof. System logic 920 may include status, configuration and control features which may include various control features disclosed herein. In some embodiments, system logic 920 executes one or more operations to be performed on sonar system 100, as described above.

System 900 may also include a memory component 924. System 900 may perform specific operations by controller 910 and other components by executing one or more sequences of instructions (e.g., system logic 920) contained in memory component 924. For example, system logic 920 may be encoded in a computer readable medium, which may refer to any medium that participates in providing instructions to controller 910 for execution. Such a medium may take many forms, including but not limited to, non-volatile media, volatile media, and transmission media. In various embodiments, non-volatile media includes optical or magnetic disks, volatile media includes dynamic memory, such as memory component 924, and transmission media includes coaxial cables, copper wire, and fiber optics, including wires that comprise bus 902. In one embodiment, system logic 920 is encoded in non-transitory computer readable medium. In one example, transmission media may take the form of acoustic or light waves, such as those generated during radio wave, optical, and infrared data communication.

Other embodiments are also contemplated. For example, although various features have been discussed in relation to a plurality of acoustic beams transmitted in a plurality of different directions offset from a common axis by a Janus angle, a single acoustic beam may be used in some embodiments. For example, a single acoustic beam (e.g., in a vertical orientation and/or other orientations) comprising a transmit waveform comprising a plurality of sub-waveforms may be transmitted from a single-beam transducer in some embodiments.

Where applicable, various embodiments provided by the present disclosure can be implemented using hardware, software, or combinations of hardware and software. Also, where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice versa.

Software in accordance with the present disclosure, such as non-transitory instructions, program code, and/or data, can be stored on one or more non-transitory machine readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

The foregoing description is not intended to limit the present disclosure to the precise forms or particular fields of use disclosed. Embodiments described above illustrate but do not limit the invention. It is contemplated that various alternate embodiments and/or modifications to the present invention, whether explicitly described or implied herein, are possible in light of the disclosure. Accordingly, the scope of the invention is defined only by the following claims.

What is claimed is:

1. A sonar system comprising:
a transducer subsystem configured to transmit a plurality of acoustic beams in a plurality of different directions offset from a common axis by a Janus angle;
wherein each acoustic beam comprises a transmit waveform comprising a plurality of sub-waveforms; and
wherein the plurality of sub-waveforms of each acoustic beam are transmitted at different center frequencies.

2. The sonar system of claim 1, wherein:
the transducer subsystem comprises a phased array transducer configured to transmit the plurality of acoustic beams; and
each sub-waveform of each acoustic beam is transmitted at an angle offset from the Janus angle.

3. The sonar system of claim 2, wherein the angle offset is determined based at least on a number of the sub-waveforms and a beamwidth of the phased array transducer.

4. The sonar system of claim 1, wherein the plurality of sub-waveforms of each acoustic beam are temporally staggered in time.

5. The sonar system of claim 1, wherein:
the plurality of sub-waveforms is a first plurality of sub-waveforms transmitted simultaneously; and
the transmit waveform of each acoustic beam further comprises a second plurality of sub-waveforms transmitted at same center frequencies and temporally staggered in time.

6. The sonar system of claim 1, wherein the plurality of sub-waveforms of each acoustic beam are modulated using minimum-shift keying (MSK).

7. The sonar system of claim 1, wherein:
the transducer subsystem comprises a plurality of piston transducers configured to transmit the plurality of acoustic beams; and
each sub-waveform of each acoustic beam is transmitted at the Janus angle.

8. The sonar system of claim 7, wherein the transducer subsystem comprises four piston transducers each configured to transmit a respective acoustic beam.

9. The sonar system of claim 1, further comprising a logic device configured to:
determine a Doppler shift of a received echo return corresponding to each sub-waveform;
separate the received echo returns through frequency-selective filtering;
estimate, for each received echo return corresponding to each sub-waveform or a combination of sub-waveforms, an independent relative velocity between the transducer subsystem and a scatterer; and
average the estimated independent relative velocities to reduce a single-ping standard deviation of a velocity error.

10. A method comprising:
transmitting, by a transducer subsystem of a sonar system, a plurality of acoustic beams in a plurality of different directions offset from a common axis by a Janus angle;
wherein each acoustic beam comprises a transmit waveform comprising a plurality of sub-waveforms; and
wherein the plurality of sub-waveforms of each acoustic beam are transmitted at different center frequencies.

11. The method of claim 10, wherein:
the transducer subsystem comprises a phased array transducer configured to transmit the plurality of acoustic beams; and
each sub-waveform of each acoustic beam is transmitted at an angle offset from the Janus angle.

12. The method of claim 11, wherein the angle offset is determined based at least on a number of the sub-waveforms and a beamwidth of the phased array transducer.

13. The method of claim 10, wherein the plurality of sub-waveforms of each acoustic beam are temporally staggered in time.

14. The method of claim 10, wherein:
the plurality of sub-waveforms is a first plurality of sub-waveforms transmitted simultaneously; and
the transmit waveform of each acoustic beam further comprises a second plurality of sub-waveforms transmitted at same center frequencies and temporally staggered in time.

15. The method of claim 10, wherein the plurality of sub-waveforms of each acoustic beam are modulated using minimum-shift keying (MSK).

16. The method of claim 10, wherein:
the transducer subsystem comprises a plurality of piston transducers configured to transmit the plurality of acoustic beams; and
each sub-waveform of each acoustic beam is transmitted at the Janus angle.

17. The method of claim 16, wherein the transducer subsystem comprises four piston transducers each configured to transmit a respective acoustic beam.

18. The method of claim 10, further comprising:
determining a Doppler shift of a received echo return corresponding to each sub-waveform;
separating the received echo returns through frequency-selective filtering;
estimating, for each received echo return corresponding to each sub-waveform or a combination of sub-waveforms, an independent relative velocity between the transducer subsystem and a scatterer; and
averaging the estimated independent relative velocities to reduce a single-ping standard deviation of a velocity error.

19. A sonar system comprising:
a transducer subsystem configured to transmit a single acoustic beam;
wherein the acoustic beam comprises a transmit waveform comprising a plurality of sub-waveforms; and
wherein the plurality of sub-waveforms of each acoustic beam are transmitted at different center frequencies.

20. A method of operating the sonar system of claim 19, the method comprising transmitting, by the transducer subsystem of the sonar system, the single acoustic beam.
